(19) United States
(12) Patent Application Publication
(10) Pub. No.: US 2015/0269585 A1
(43) Pub. Date: Sep. 24, 2015

(54) DEVICE RETIREMENT PROBABILITY RATE

(71) Applicant: CELLCO PARTNERSHIP D/B/A VERIZON WIRELESS, Basking Ridge, NJ (US)

(72) Inventors: Siva PATNAM, Edison, NJ (US); Vijayakumar PANDIARAJAN, Canton, MI (US)

(73) Assignee: CELLCO PARTNERSHIP D/B/A VERIZON WIRELESS, Basking Ridge, NJ (US)

(21) Appl. No.: 14/223,619

(22) Filed: Mar. 24, 2014

(51) Int. Cl. G06Q 30/00

(52) U.S. Cl. CPC G06Q 30/014

(57) ABSTRACT

Systems and methods for determining an action plan with respect to a returned device are disclosed. In some implementations, a computer receives an identifier of a returned device being processed by a replacement center. The computer provides the identifier of the returned device to a data repository. The computer receives, from the data repository, in response to the identifier of the returned device, data related to the returned device. The computer calculates a device retirement metric based on the data related to the returned device received from the data repository. The computer determines, based on the device retirement metric, an action plan to take with respect to the returned device. The computer provides an indication of the action plan with respect to the returned device.

### BACKGROUND

Customers purchase mobile phones from mobile phones manufactures and/or mobile service providers. In some cases, the mobile phone may not function properly due to, for example, a manufacturing defect. In these cases, the customer may return the mobile phone to the seller and the seller may provide a certified like-new replacement mobile phone to the customer. The certified like-new replacement mobile phone may be a new mobile phone received from the manufacturer or a mobile phone that has been previously returned through the certified like-new replacement program, tested by the manufacturer or seller, and found to have no defects or fixed to remedy the previously identified defect.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary flow diagram for processing a returned device through a device return center;

FIG. 2 illustrates an exemplary system for determining an action plan with respect to a returned device;

FIG. 3 illustrates an exemplary process for determining an action plan with respect to a returned device;

FIG. 4 is a simplified functional block diagram of a computer that may be configured to function as the data repository or the messaging server shown in FIG. 2; and

FIG. 5 is a simplified functional block diagram of a personal computer or other work station or terminal device, which may be configured to function as the computing machine shown in FIG. 2.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

As set forth above, in some cases, a customer may return a recently-purchased mobile phone to a seller if the mobile phone is not functioning properly. The seller may issue a certified like-new replacement mobile phone to the customer in exchange for the returned mobile phone. After receiving the returned mobile phone from the customer, the seller may have multiple options in dealing with the returned mobile phone. The multiple options may include returning the mobile phone to another customer through the certified like-new replacement program, selling the mobile phone in a bid sale (at a discount as a known defective device), or retiring the mobile phone. The decision regarding which action to take with respect to the returned mobile phone is typically made by an employee of the seller, who may be provided with little guidance in making an optimal decision with respect to the returned mobile phone. A decision may be optimal if the decision, among other things, saves money for the seller, allows the seller's certified like-new replacement customers to receive problem-free devices, allows the seller to have a reputation for providing problem-free certified like-new replacement devices, etc. To this end, in some situations, the employee's decision may be suboptimal (e.g., a device that could have been provided to a new customer under the certified like-new replacement program is instead sold in a bid sale or retired). As the foregoing illustrates, a new approach may be desirable in determining a correct course of action with respect to the returned mobile device.

The subject technology provides techniques for automatically determining, via a computer system associated with a certified like-new replacement center, a proper course of action with respect to the mobile phone returned to a cellular carrier or manufacture associated with the mobile phone. Although the instant application describes the subject technology with respect to a mobile phone, one of ordinary skill in art recognizes that the device, which is returned and processed through the certified like-new replacement center, is not limited to the mobile phone and can include other type of devices. The other devices may include, for example, an electronic device, a mechanical device, or any other device. An electronic device may include a mobile phone, a tablet computer, a laptop computer, a desktop computer, a digital music player, a television, a monitor, a router, a modem, a stereo system, etc. A mechanical device may include a bicycle, an exercise machine, a vehicle, etc. Other device(s) may include kitchen equipment (e.g., microwave, toaster, stove, oven, dishwasher, etc.), furniture (e.g., table, chair, couch, bed, desk, etc.), vehicle equipment (e.g., tire, vehicle-based speakerphone, vehicle-based stereo system, vehicle-based television, etc.), etc. Common features among some or all of these devices may include, among other things and with some exceptions, that the devices are sold to end-user consumers by business sellers and are sometimes returned to seller(s) or manufacturer(s) due to their being defective or not operating properly. When returning a device to a seller or a manufacturer, an end-user consumer may request a certified like-new replacement in place of the original device, which was defective or not operating properly. The certified like-new replacement center may be operated by any entity associated with a seller or a manufacturer of the device.

In deciding which action to take on a returned device, the certified like-new replacement center may be concerned with multiple factors, including saving money by purchasing or ordering fewer new devices from the manufacturer, reducing the bounce rate (the probability that a specific returned device will be returned again if it is provided to a new customer), reducing the broken promise rate (the number of times a user has to return his/her device through the certified like-new replacement program), and/or increasing revenue from a bid sale (at a discount as a known defective device).

According to some implementations, when a customer returns a device to the certified like-new replacement center, a certified like-new replacement device is provided to the customer. The returned device is then tested by a centralized returns & testing center. The centralized returns & testing center may include a single center, multiple centers, or any combination of location(s). In some cases, there may be consistency checks so that multiple center(s) make the same or similar decisions regarding action(s) to take with returned device(s). If the centralized returns & testing center finds a defect in the returned device, the returned device is provided to the manufacturer for repair. If the centralized returns & testing center finds no defect or after the manufacturer repairs the returned device, the returned device is placed in the certified like-new replacement inventory.

After being placed in the certified like-new replacement inventory, the returned device is processed by a supply chain management module executing on one or more computers associated with the certified like-new replacement center. The supply chain management module of the one or more computers, when executed, causes a processor of the one or more computers to receive an identifier of the returned device. The identifier of the returned device may be, for example, an International Mobile Equipment Identity (IMEI) number if the returned device is a mobile phone or a manufacturer identity number of another device. The processor provides the identifier of the returned device to a data repository. The processor may access the data repository via a network or via a direct wired or wireless connection between the one or more computers and the data repository. Alternatively, the data repository may reside within the one or more computers.

The processor, via operation of the supply chain management module, receives from the data repository, in response to the identifier of the returned device, data related to the returned device. The data related to the returned device in one embodiment includes: a cycle number of the returned device at the certified like-new replacement center, an initial cost of the returned device, a remaining useful life of the returned device, an inventory cost of the returned device, a repairing/testing cost for processing the returned device, and a shipping cost for providing the returned device to a new customer.

The cycle number of the returned device at the certified like-new replacement center is defined as the number of times any customer has returned the device or, in other words, the number of times the device has been processed by the certified like-new replacement center. For example, a device that was provided to customer A, then returned by customer A, then provided to customer B, and then returned by customer B has a cycle number of two. The higher the cycle number of the returned device, the more likely the returned device is to have a defect that cannot easily be fixed and the more likely the returned device is to be a candidate for a bid sale or retirement, rather than provisioned to the new customer under the certified like-new replacement program.

The initial cost of the returned device includes the price for which a brand new version of the returned device is sold by the seller. The greater the initial cost, the less likely the returned device is to be a candidate for a bid sale or retirement, and the more likely the device is to be provided to a new customer under the certified like-new replacement program, as the returned device is more expensive to replace. In some cases, the seller may sell a device (e.g., a mobile phone) for a lower price if the buyer signs a service contract with a cellular carrier. The initial cost may refer to the unsubsidized price for which the device is sold without being coupled with a service contract (e.g., if a customer wishes to buy the device without signing a service contract).

The remaining useful life measures the estimated (or known) amount of time until a new version of the returned device will be placed on the market, rendering the returned device obsolete. For example, if the returned device is an Apple iPhone 5®, the current date is March 2013, and a new version of the Apple iPhone® is expected to appear on the market in September 2013, the remaining useful life of the returned device is six months (the time difference between March 2013 and September 2013). The shorter the remaining useful life, the more likely the returned device is to be a candidate for a bid sale or retirement, rather than for provisioning to the new customer under the certified like-new replacement program.

The inventory cost measures a cost associated with storing the returned device in inventory until the returned device is provided to a new customer. The inventory cost may depend on the price of space in a store or a warehouse, the size of the returned device, and the estimated amount of time before the new customer will request the returned device. The greater the inventory cost, the more likely the returned device is to be a candidate for a bid sale or retirement, rather than for provision to the new customer under the certified like-new replacement program.

The repairing/testing cost measures a cost associated with testing the device for defects, and repairing any discovered defects. The repairing/testing cost may include the cost of the technician's time and use of the technician's tools. The greater the repairing/testing cost, the more likely the returned device is to be a candidate for a bid sale or retirement, rather than for provision to the new customer under the certified like-new replacement program.

The shipping cost measures the cost of shipping the device to the new customer, for example, via a postal service or a private shipping company. The greater the shipping cost, the more likely the returned device is to be a candidate for a bid sale or retirement, rather than for provision to the new customer under the certified like-new replacement program.

Returning to the discussion of the operation of the processor executing the supply chain management module, the processor calculates a device retirement metric based on the data related to the returned device received from the data repository set forth above. The device retirement metric may be calculated according to an equation that is selected based on the make model and characteristics (e.g., color, amount of random access memory, amount of read only memory, etc.). For example, a 16 GB pink Apple iPhone 5C® may have a different equation from a 32 GB yellow Apple iPhone 5C®, and a different equation from a 16 GB black Samsung Galaxy S4®.

The processor executing the supply chain management module determines, based on the device retirement metric, an action to take with respect to the returned device. In some implementations, the device retirement metric may be a whole number between 1 and 10. When the device retirement metric is between 1 and 4, the action may be providing the returned device as a certified like-new replacement to a new customer. When the device retirement metric is between 5 and 7, the action may be selling the returned device in a bid sale. When the device retirement metric is between 8 and 10, the action may be retiring the returned device. The device retirement probability metric may be a probability rank given to a specific device having a specific device identifier (e.g., serial number) based on the life-to-date bounce cycle of the device and the total cost, which may be calculated dynamically on a daily basis. A notification of the action plan may be provided to an appropriate party, for example, an employee of the seller or the centralized return & testing center. In some cases, if unusual results occur (e.g., an action plan of retiring the returned device is provided where the device may be profitably sold in a bid sale), comparisons may be made to similar devices to override or modify the action plan in the unusual result.

The processor executing the supply chain management module provides an indication of the determined action to take with respect to the returned device. The indication of the determined action may be provided via a display unit of the one or more computers or via an electronic message (e.g., an email message, a short messaging service message, or a push notification to a mobile phone) to an employee in the certified like-new replacement center. In some cases, the processor may provide the indication of the determined action individually for each returned device as the processor processes the returned device. In some cases, the processor may provide indications of determined actions for multiple returned devices together in a batch once every threshold time period (e.g., once per day). Alternatively, the processor may provide the indication of the determined action when the returned device is to be sent out from the return center. The notification technique (e.g., electronic message or via display unit) may be set by an employee of the return center based on hardware available to the employee (e.g., whether the processor is connected to a display unit, whether the employee has a smartphone capable of receiving electronic messages, etc.).

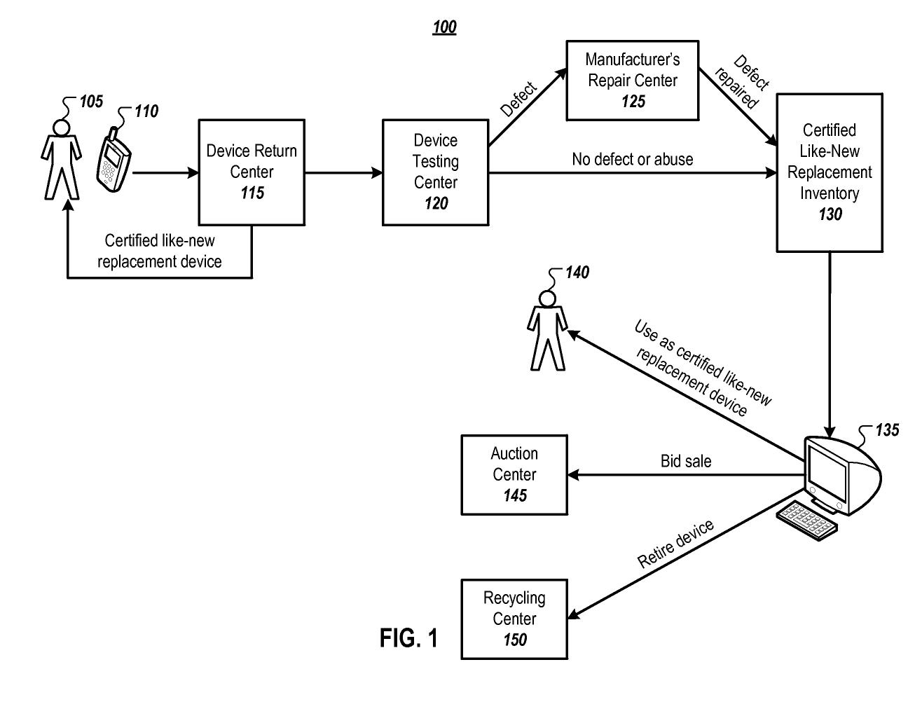

FIG. 1 illustrates an exemplary flow diagram 100 for processing a returned device through a device return center. As shown in the flow diagram 100, a customer 105 returns a device 110 (e.g., a mobile phone) to a device return center 115 and indicates that the device is not working properly. After running a predetermined set of basic tests on the device (e.g., to verify that there is no water damage and/or that a problem about which the customer complained exists) and/or verifying that the device is still covered by the manufacturer's or seller's warranty, a certified like-new replacement device from the inventory of the device return center 115 is provided to the customer 105. The predetermined set of basic tests may be automated and may include, for example, scanning the device, checking a water damage indicator on the device, checking the device for abuse or physical damage, etc. The predetermined set of basic tests may include manual tests in place of or in addition to the automated tests.

The device 110 is then forwarded to the device testing center 120 for further testing of the device 110. The further testing may be automated and may include a set of automated or manual tests, created by the manufacturer or the seller, for checking the device for defects or abuse. The set of tests may include tests for various components of the device, for example, in the case of a mobile phone, tests for the screen, the battery, the speaker, the microphone, the cellular network interface, the WiFi network interface, etc. The further testing may include manual tests in place of or in addition to the automated tests. At the device testing center 120, if the device 110 is found to have a defect, the device 110 is sent to the manufacturer's repair center 125, where the defect is repaired. After repairing the defect, the device 110 is placed in the seller's certified like-new replacement inventory 130. If, at the device testing center 120, the device 110 is not found to have a defect or is not found to have been abused, the device 110 is placed directly into the certified like-new replacement inventory 130.

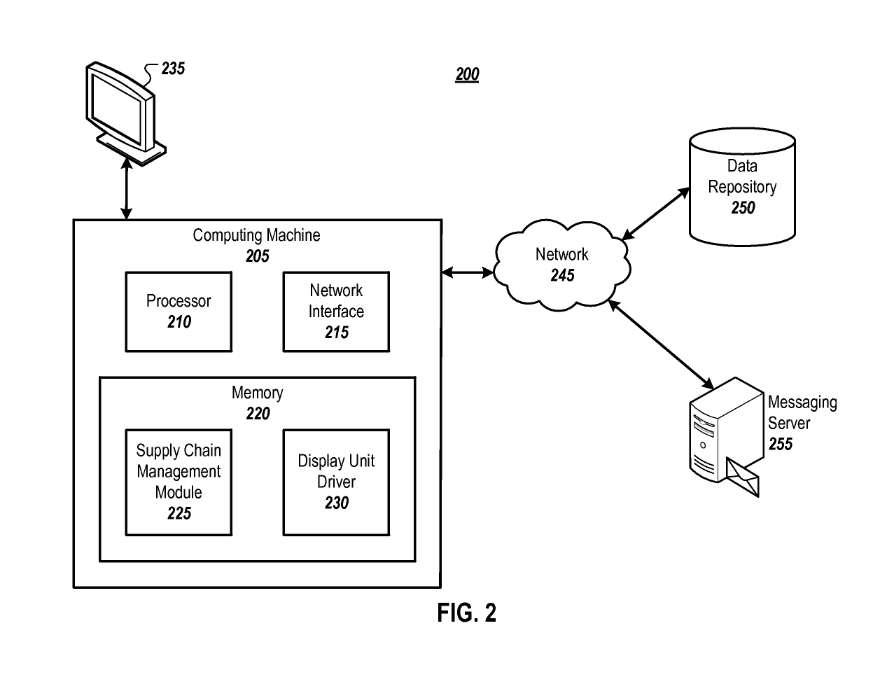

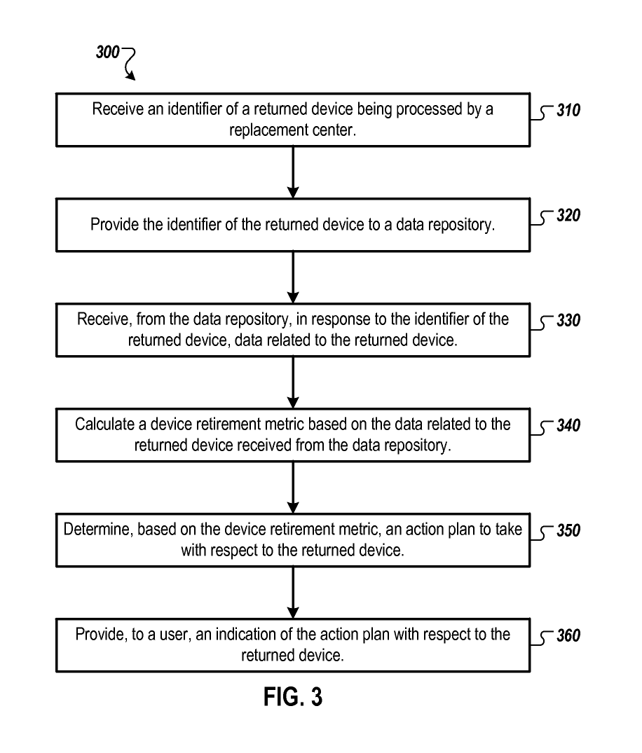

Upon arrival at the certified like-new replacement inventory 130, the device 110 is processed by a computing machine 135. For example, an employee may scan a bar code of the device 110 into the computing machine 135 or enter an identity number (e.g., an IMEI number) into the computing machine 135. Alternatively, near field technologies such as NFC may be used to relay the device identity information from the device 110 into the computing machine 135. Using the techniques described herein, for example, in conjunction with FIGS. 2 and 3, below, the computing machine 135 determines an action plan for the device 110 and provides an indication of the action plan to the employee or to another person. The indication of the action plan may be provided via a display unit of the computing machine or via an electronic message (e.g., an email message, a short messaging service (SMS) message, or a push notification to a cellular phone) to the employee or the other person.

The action plan may be to use the device 110 as a certified like-new replacement device, in which case the device 110 may be provided as a certified like-new replacement device to a new customer 140. The action plan may be to sell the device 110 in a bid sale as a known defective device, in which case the device 110 may be provided to an auction center 145 for selling in a bid sale, for example, via an online auction or a live in-person auction. The action plan may be to retire the device 110, in which case the device may be provided to a recycling center 150.

FIG. 2 illustrates an exemplary system 200 for determining an action plan with respect to a returned device. The returned device may correspond to the returned device 110 of FIG. 1. As shown, the system 200 includes a computing machine 205 capable of communicating with a data repository 250 and a messaging server 255 via a network 245. The network 245 may include one or more of the Internet, an intranet, a cellular network, a local area network, a wide area network, a wired network, a wireless network, etc.

The computing machine 205 may be a laptop computer, a desktop computer, a tablet computer, a mobile phone, a handheld scanner coupled with a processor and memory, etc. While the computing machine 205 is illustrated as a single machine, in some aspects, the functions of the computing machine 205 may be carried out by two or more machines, for example, a handheld scanner may be connected to a remote machine including a processor and a memory.

As shown, the computing machine 205 includes a processor 210, a network interface 215, and a memory 220. The computing machine 205 is coupled with a display unit 235. The display unit 235 may include one or more screens, a projector, etc. The processor 210 executes programmed instructions, which may be stored in the memory 220. While a single processor 210 is illustrated, the computing machine 205 may have one or multiple processors. If there are multiple processors, the multiple processors may together carry out the functionality of the processor 210 described herein. The multiple processors may be arranged in processing unit(s), for example, a central processing unit (CPU) or a graphics processing unit (GPU). The network interface 215 connects the computing machine 205 to the network 245. The network interface 215 may include one or more network interface controllers (NICs). The memory 220 stores data or instructions. As shown, the memory 220 stores a supply chain management module 225 and a display unit driver 230.

The display unit driver 230 includes instructions which, when executed by the processor 210, cause the processor 210 to control the operation of the display unit 235. For example, the display unit driver 230 may cause image or video data stored at the computing machine 205 or received at the computing machine 205 via the network 245 to be rendered for display at the display unit 235 by operation of the processor 210.

The supply chain management module 225 includes instructions which, when executed by the processor 210, cause the processor 210 to determining the action plan with respect to the returned device. When executing the supply chain management module 225, the processor 210 receives an identifier (e.g., an identity number assigned by the manufacturer or an IMEI number) of the returned device. For example, a user may scan the returned device or manually enter the identifier using a keyboard, a keypad, or a touchscreen. The processor 210 provides the identifier of the returned device to the data repository 250. For example, the processor 210 may transmit the identifier of the returned device to the data repository 250 using network 245, which is accessed via the network interface 215.

The processor 210 receives, from the data repository 250 and in response to the identifier of the returned device, data related to the returned device. The data related to the returned device that is received from the data repository 250 may include at least one of: a cycle number of the returned device, an initial cost of the returned device, a remaining useful life of the returned device, an inventory cost of the returned device, a repairing/testing cost of the returned device, and a shipping cost for providing the returned device to a new customer. In some cases, the data related to the returned device includes each of: the cycle number of the returned device, the initial cost of the returned device, the remaining useful life of the returned device, the inventory cost of the returned device, the repairing/testing cost of the returned device, and the shipping cost for providing the returned device to the new customer.

The processor 210 calculates a device retirement metric based on the data related to the returned device received from the data repository. The processor 210 determines, based on the calculated device retirement metric, the action plan to take with respect to the returned device. The processor 210 provides, to the user, an indication of the action plan with respect to the returned device. For example, the processor 210 may provide the indication of the action plan via the display unit 235 in conjunction with the display unit driver 230. The display unit 235 may be visible to the user. Alternatively, the processor 210 may provide the indication of the action plan via an electronic message (e.g., email, SMS, or push notification) to the user. The processor 210 may signal, via the network 245, for the messaging server 255 to send the electronic message to the user.

The data repository 250 stores information about devices that may be processed by the computing machine 205. As set forth above, for each device sold by a seller and/or manufactured by a manufacturer, the data repository 250 stores data that may include at least one of: a cycle number of the device, an initial cost of the device, a remaining useful life of the device, an inventory cost of the device, a repairing/testing cost of the device, and a shipping cost for providing the device to a new customer. In some cases, the data repository 250 stores each and every one of: the cycle number of the device, the initial cost of the device, the remaining useful life of the device, the inventory cost of the device, the repairing/testing cost of the device, and the shipping cost for providing the device to the new customer. The data repository 250 may store equation(s) for calculating the device retirement metric based on a make and model of the returned device and/or based on a color and an amount of memory of the returned device.

The messaging server 255 may be capable of transmitting messages. For example, the messaging server 255 may include one or more of: a mail server capable of transmitting email messages, a SMS center capable of transmitting SMS messages, or a push server capable of transmitting push notifications. The messaging server 255 may transmit messages between computing devices, including the computing machine 205, via the network 245.

FIG. 3 illustrates an exemplary process 300 for determining an action plan with respect to a returned device. The process 300 begins at step 310, where a computing machine (e.g., computing machine 205 executing supply chain management module 225 via processor 210) that includes one or more computing devices receives an identifier of a returned device being processed by a replacement center. The returned device may be a mobile phone or any other device. If the returned device is a mobile phone, the identifier may be an IMEI number of the mobile phone. If the returned device is any other device, the identifier may be a manufacturer's identification number for the device.

In step 320, the computing machine provides the identifier of the returned device to a data repository (e.g., data repository 250). The computing machine may communicate with the data repository via a network (e.g., network 245), the data repository may reside within a local memory (e.g., memory 220) of the computing machine, or the computing machine may be connected to the data repository via a direct wired or wireless connection. The data repository may store data about the returned device and other device(s) sold by the same seller or manufactured by the same manufacturer. The data about the returned device may include, among other things, a make, a model, a color, or an amount of memory of the returned device. The data about the returned device may include, among other things, a cycle number of the returned device, an initial cost of the returned device, a remaining useful life of the returned device, an inventory cost of the returned device, a repairing/testing cost of the returned device, or a shipping cost for providing the returned device to a new customer.

In step 330, the computing machine receives, from the data repository, in response to the identifier of the returned device, data related to the returned device. The data related to the returned device may include, among other things, any of the data set forth above.

In step 340, the computing machine calculates a device retirement metric based on the data related to the returned device received from the data repository. The device retirement metric may be calculated using an equation stored at the data repository and provided to the computing machine by the data repository. The equation may be selected based on a make and model of the returned device. The equation may be selected based on a color and an amount of memory of the returned device. In one example, an Apple iPhone 5S® may have a different equation than a Samsung Galaxy S4®. In another example, an Apple iPhone 5S® having a 16 GB memory may have a different equation than an Apple iPhone 5S® having a 32 GB memory. In yet another example, an Apple iPhone 5S® having a 16 GB memory and a space grey color may have a different equation than an Apple iPhone 5S® having a 16 GB memory and a gold color. In one implementation the equation states that the device retirement metric is equal to the cycle number. In another implementation, the equation states that the device retirement metric is equal to a product of the cycle number and the remaining useful life in months subtracted from 24.

In step 350, the computing machine determines, based on the device retirement metric, an action plan to take with respect to the returned device. The action plan may include providing the returned device as a certified like-new replacement device to a new customer in a case where the device retirement metric is within a first range; selling the returned device in a bid sale in a case where the device retirement metric is within a second range; and retiring the returned device in a case where the device retirement metric is within a third range. The first range may correspond to the device retirement metric being less than a first threshold (e.g., 4.5/10). The second range may correspond to the device retirement metric being greater than the first threshold and less than a second threshold (e.g., 7.5/10). The third range may correspond to the device retirement metric being greater than the second threshold.

In step 360, the computing machine provides, to a user, an indication of the action plan with respect to the returned device. The user may be an employee of the seller or the manufacturer who is responsible for handling the returned device. The indication of the action plan may be provided to the user via a display unit (e.g., display unit 235) of the computing machine, or via an electronic message. The electronic message may be transmitted via email, SMS, or a push notification to a cellular phone. After step 360, the process 300 ends.

TABLE 1
Action Plans for Mobile Phone XYZ Under Various Data Values

| | Initial | Remaining | Inventory | Repairing/ | Shipping | Device | |
|---|---|---|---|---|---|---|---|
| Cycle | Cost | Useful Life | Cost | Testing Cost | Cost | Retirement | Action |
| Number | (USD) | (months) | (USD) | (USD) | (USD) | Metric | Plan |
| 1 | 100 | 20 | 5 | 5 | 15 | 1 | CLNR |
| 2 | 100 | 18 | 10 | 5 | 15 | 2 | CLNR |
| 3 | 100 | 16 | 15 | 5 | 15 | 3 | CLNR |
| 4 | 100 | 14 | 20 | 5 | 15 | 4 | CLNR |
| 5 | 100 | 12 | 25 | 5 | 15 | 5 | Bid |
| 6 | 100 | 10 | 30 | 5 | 15 | 6 | Bid |
| 7 | 100 | 8 | 40 | 5 | 15 | 7 | Bid |
| 8 | 100 | 6 | 50 | 5 | 15 | 8 | Retire |
| 9 | 100 | 4 | 60 | 5 | 15 | 9 | Retire |
| 10 | 100 | 2 | 70 | 5 | 15 | 10 | Retire |

Table 1 illustrates action plans for a specific brand of mobile phone, “Mobile Phone XYZ” under various data values, which may be stored in a data repository (e.g., data repository 250) and provided to a computing machine (e.g., computing machine 205) in response to a request from the computing machine. In Table 1, the abbreviation “USD” refers to United States Dollars, “CLNR” refers to “use returned device as certified like-new replacement,” “Bid” refers to “sell returned device in bid sale,” and “Retire” refers to “retire returned device.” In the example of Table 1, the initial cost, repairing/testing cost, and shipping cost are constant, as the initial, unsubsidized price of the mobile phone does not change and repairing/testing and shipping costs are fixed as agreed between the seller and its employees (e.g., employees who repair or test the device make a fixed salary or wage) or its vendors (e.g., a shipping company charges a flat rate to ship the mobile device from the warehouse to any location in the United States). The remaining useful life may decrease by two months between each cycle as a cycle (device being provided to customer, device being returned by customer, device being tested, etc.) may last two months. The inventory cost may increase by $5 after each cycle due to increasing costs of storing inventory, for example, increasing rents or decreasing availability of warehouse or storage space. The initial cost, repairing/testing cost, and shipping cost may be constant due to a constant initial cost, a constant cost for standard repairs and tests, and constant shipping prices charged by postal or shipping companies.

A larger device retirement metric is shown to correspond to an action plan of “bid” or “retire.” As shown, the device retirement metric may be calculated using any of the following equations:

DR=CN (1)

DR=(22−RUL)/2 (2)

In equations (1) and (2) DR stands for device retirement metric, CN stands for cycle number, and RUL stands for remaining useful life. In Table 1 and equations (1) and (2), the device retirement metric is shown to increase as the cycle number increases, as the remaining useful life decreases, and as the inventory cost increases. The device retirement metric may increase as the cycle number increase because, as the cycle number increases, the likelihood that the mobile phone will experience problems again increases. The device retirement metric may increase as the remaining useful life decreases because the probability that a new customer will desire the device, as well as the possible bid sale price, decreases. The device retirement metric may increase as the inventory cost increases because the device may need to be kept in inventory for a longer time if the device is to be provided as a certified like-new replacement device than if the device is to be retired or sold in a bid sale. In an alternative implantation, a smaller retirement metric may correspond do an action plan of “bid” or “retire.”

Table 1 illustrates one possible relationship between the values set forth in Table 1 and persons skilled in the relevant art will recognize that other relationships are possible. For example, as shown in Table 1, as the device retirement metric increases, the action plan is more likely to be “bid” or “retire.” However, in an alternative implementation, as the device retirement metric decreases, the action plan may be more likely to be “bid” or “retire.” Examples of equations for calculating the device retirement metric are provided in equations (1) and (2) above.

In some cases, the action plan may be automated, controlled, and/or determined by the device itself in addition to or in place of the computing device of the return center, as described above. For example, a returned smart mobile phone, tablet computer, or laptop computer may itself function as the computing machine (e.g., computing machine 205 or the computing machine implementing the process 300) described herein.

In some cases, a data repository (e.g., data repository 250 or another data repository) may be used to keep track of return rates and successful/unsuccessful defect repair rates for various devices. If some device models are returned frequently (e.g., over 5% of sold devices are returned), the manufacturer or seller may mark those models for expiration and be more likely to sell devices of those models in a bid sale or retire devices of those models. In some cases, the device retirement metric may be used to order device(s) for provision to customers. For example, an Apple iPhone 5C® having a device retirement metric of 3 may be provided to a new customer seeking a certified like-new replacement before an Apple iPhone 5C® having a device retirement metric of 2, as the device with the larger retirement metric is closer to being sold in a bid sale and, thus, needs to be provided to a customer sooner. Alternatively, the device with the lower device retirement metric may be provided to the new customer first as it is less likely to be returned due to a defect again.

In some cases, certified like-new replacement device(s) may be provided to local stores in location(s) where those replacement devices are requested frequently. For example, if replacement Apple iPhone 5C® devices are frequently requested in Los Angeles and replacement Samsung Galaxy S4® devices are frequently requested in Chicago, a returned Apple iPhone 5C® that is to be used in the certified like-new replacement program may be shipped to a local store in Los Angeles and a returned Samsung Galaxy S4® that is to be used in the certified like-new replacement program may be shipped to a local store in Chicago.

In some implementations, a supply chain analytics dashboard, implemented on a computer, may extract the cycle number, initial device cost, average shelf useful life of the product, average inventory cost for the stock keeping unit (SKU), centralized returns & testing center's testing and shipping cost. The supply chain analytics dashboard may rely on various supply chain management techniques, such as inventory management system, point of sale system, testing center system, etc., to determine the above costs/values. Based on the cost information, the computer may dynamically calculate the total life-to-date ownership cost of the product and also the bounce history with cycle number. When the life-to-date cost exceeds the value derived out of the device, the device is marked for bid sale or retirement.

In the example of Table 2, after cycle number 5, the total cost for Device ABC exceeds the device cost, the rate of return and the probability of bounce is higher, and the shelf life of the device model for the given SKU is low. Thus, it financially makes more sense to get a new device from the manufacturer rather than putting the old device back in the certified like-new replacement loop. At cycle number 8 in Table 2, the device costs more to hold in the inventory than to place in the certified like-new replacement loop or keep for a bid sale. Thus, at cycle number 8, the device may be recycled.

TABLE 2
Action Plans for Device ABC Under Various Data Values

| | Initial | Remaining | Inventory | Repairing/ | LTD | Shipping | LTD | Device | | |
|---|---|---|---|---|---|---|---|---|---|---|
| Cycle | Cost | Useful Life | Cost | Testing Cost | Repair | Cost | Shipping | Retirement | Total | Action |
| No. | (USD) | (months) | (USD) | (USD) | Cost | (USD) | Cost | Metric | Cost | Plan |
| 1 | 100 | 20 | 5 | 5 | 5 | 15 | 15 | 1 | 25 | CLNR |
| 2 | 100 | 18 | 10 | 5 | 10 | 15 | 30 | 2 | 50 | CLNR |
| 3 | 100 | 16 | 15 | 5 | 15 | 15 | 45 | 3 | 75 | CLNR |
| 4 | 100 | 14 | 20 | 5 | 20 | 15 | 60 | 4 | 100 | CLNR |
| 5 | 100 | 12 | 25 | 5 | 25 | 15 | 75 | 5 | 125 | Bid |
| 6 | 100 | 10 | 30 | 5 | 30 | 15 | 90 | 6 | 150 | Bid |
| 7 | 100 | 8 | 40 | 5 | 35 | 15 | 105 | 7 | 180 | Bid |
| 8 | 100 | 6 | 50 | 5 | 40 | 15 | 120 | 8 | 210 | Retire |
| 9 | 100 | 4 | 60 | 5 | 45 | 15 | 135 | 9 | 240 | Retire |
| 10 | 100 | 2 | 70 | 5 | 50 | 15 | 150 | 10 | 270 | Retire |

In sum, according to some implementations, a computing machine receives an identifier of a returned device being processed by a replacement center. The computing machine provides the identifier of the returned device to a data repository. The computing machine receives, from the data repository, in response to the identifier of the returned device, data related to the returned device. The data related to the returned device includes at least one of a cycle number of the returned device, an initial cost of the returned device, a remaining useful life of the returned device, an inventory cost of the returned device, a repairing/testing cost of the returned device, and a shipping cost for providing the returned device to a new customer. The computing machine calculates a device retirement metric based on the data related to the returned device received from the data repository. The computing machine determines, based on the device retirement metric, an action plan to take with respect to the returned device. The computing machine provides, to a user, an indication of the action plan to take with respect to the returned device.

As shown by the above discussion, functions relating to determining an action plan with respect to a returned device may be implemented on computers connected for data communication via the components of a packet data network, operating as the computing machine 205, the network 245, the data repository 250, and the messaging server 255, shown in FIG. 2. Although special purpose devices may be used, such devices also may be implemented using one or more hardware platforms intended to represent a general class of data processing device commonly used to run “client” or “server” programming so as to implement the functions discussed above.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the supply chain management module 225 or the display unit driver 230. The software code is executable by the general-purpose computer that functions as the computing machine 205, the data repository 250, or the messaging server 255. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for determining an action plan with respect to a returned device, in essentially the manner performed in the implementations discussed and illustrated herein.

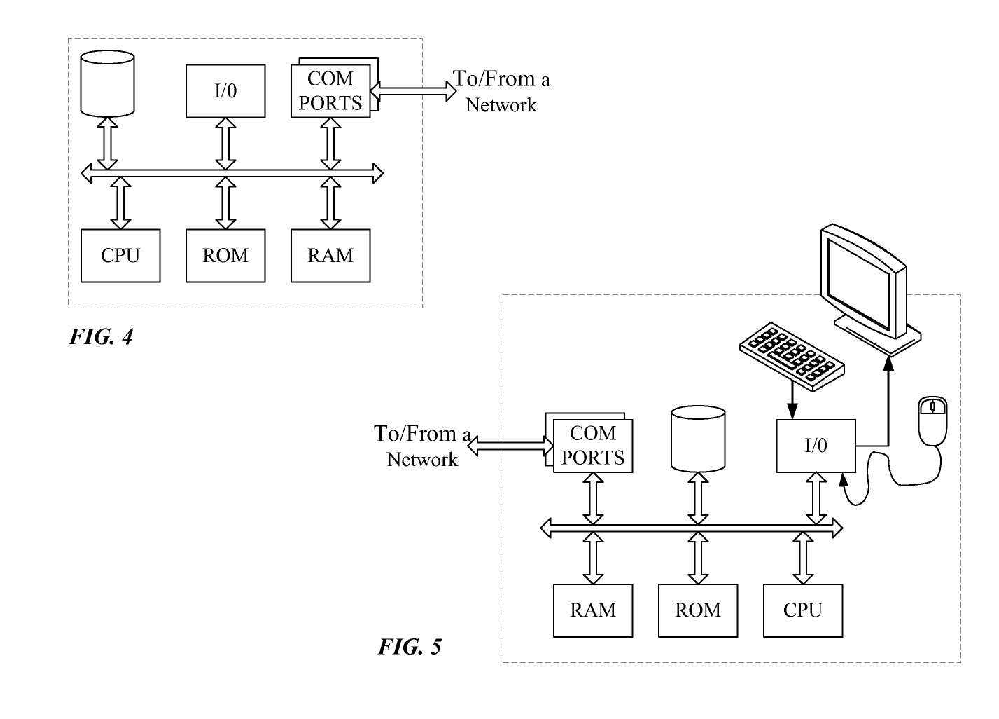

FIGS. 4 and 5 provide functional block diagram illustrations of general purpose computer hardware platforms. FIG. 4 illustrates a network or host computer platform, as may typically be used to implement a server. FIG. 5 depicts a computer with user interface elements, as may be used to implement a personal computer or other type of work station or terminal device, although the computer of FIG. 5 may also act as a server if appropriately programmed. It is believed that the general structure and general operation of such equipment as shown in FIGS. 4 and 5 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 5). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, examples of the methods of determining an action plan with respect to a returned device outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the supply chain management module 225, the display unit driver 230, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a Blu-ray disc read-only memory (BD-ROM), CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

These general and specific aspects may be implemented using a system, a method, a computer program, a computer readable medium, or an apparatus or any combination of systems, methods, computer programs, computer readable mediums, and/or apparatuses

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a computer, an identifier of a returned device being processed by a replacement center;
providing, via the computer, the identifier of the returned device to a data repository, the data repository being accessible to the computer via a network;
receiving, at the computer and from the data repository, in response to the identifier of the returned device, data related to the returned device, the data related to the returned device including at least one of a cycle number of the returned device, an initial cost of the returned device, a remaining useful life of the returned device, an inventory cost of the returned device, a repairing/testing cost of the returned device, and a shipping cost for providing the returned device to a new customer;
calculating, at the computer, a device retirement metric based on the data related to the returned device received from the data repository;
determining, based on the device retirement metric, an action plan to take with respect to the returned device; and
providing, to a user and via the computer, an indication of the action plan with respect to the returned device.

2. The method of claim 1, wherein the cycle number of the returned device measures a number of times the device has been processed by the replacement center.

3. The method of claim 1, wherein the initial cost of the returned device measures an unsubsidized price of the returned device.

4. The method of claim 1, wherein the remaining useful life of the returned device measures an estimated or known time remaining until an updated version of the device is provided by a manufacturer of the device.

5. The method of claim 1, wherein the inventory cost of the returned device measures a price associated with storing the returned device in inventory until the device is provided the new customer or retired.

6. The method of claim 1, wherein the repairing/testing cost of the returned device measures a price associated with repairing or testing the returned device.

7. The method of claim 1, wherein the action plan includes providing the returned device as a certified like-new replacement to the new customer in a case where the device retirement metric is less than a first threshold.

8. The method of claim 1, wherein the action plan includes selling the returned device in a bid sale in a case where the device retirement metric is greater than a first threshold and less than a second threshold.

9. The method of claim 1, wherein the action plan includes retiring the returned device in a case where the device retirement metric is greater than the second threshold.

10. The method of claim 1, wherein the device retirement metric is calculated using an equation selected based on a make and model of the returned device.

11. The method of claim 1, wherein the device retirement metric is calculated using an equation selected based on a color and an amount of memory of the returned device.

12. The method of claim 1, wherein the indication of the action plan is provided via an electronic message to the user.

13. The method of claim 1, wherein the indication of the action plan is provided via a display unit of the computer that is visible to the user.

14. The method of claim 1, wherein:
the returned device includes a mobile phone, and
the identifier of the returned device includes an International Mobile Equipment Identity (IMEI) number.

15. A non-transitory computer-readable medium comprising instructions which, when executed by a computer, cause the computer to:
receive an identifier of a returned device being processed by a replacement center;
provide the identifier of the returned device to a data repository;
receive, from the data repository, in response to the identifier of the returned device, data related to the returned device, the data related to the returned device including at least one of a cycle number of the returned device, an initial cost of the returned device, a remaining useful life of the returned device, an inventory cost of the returned device, a repairing/testing cost of the returned device, and a shipping cost for providing the returned device to a new customer;
calculate a device retirement metric based on the data related to the returned device received from the data repository;
determine, based on the device retirement metric, an action plan to take with respect to the returned device; and
provide, to a user, an indication of the action plan with respect to the returned device.

16. The computer-readable medium of claim 15, wherein the data related to the returned device includes each and every one of the cycle number of the returned device, the initial cost of the returned device, the remaining useful life of the returned device, the inventory cost of the returned device, the repairing/testing cost of the returned device, and the shipping cost for providing the returned device to the new customer

17. The computer-readable medium of claim 15, wherein the action plan includes providing the returned device as a certified like-new replacement to the new customer in a case where the device retirement metric is less than a first threshold.

18. The computer-readable medium of claim 15, wherein the action plan includes selling the returned device in a bid sale in a case where the device retirement metric is greater than a first threshold and less than a second threshold.

19. The computer-readable medium of claim 15, wherein the action plan includes retiring the returned device in a case where the device retirement metric is greater than the second threshold.

20. A system comprising:
a processor; and
a memory comprising instructions which, when executed by the processor, cause the processor to:
receive an identifier of a returned device being processed by a replacement center;
provide the identifier of the returned device to a data repository;
receive, from the data repository, in response to the identifier of the returned device, data related to the returned device, the data related to the returned device including at least one of a cycle number of the returned device, an initial cost of the returned device, a remaining useful life of the returned device, an inventory cost of the returned device, a repairing/testing cost of the returned device, and a shipping cost for providing the returned device to a new customer;
calculate a device retirement metric based on the data related to the returned device received from the data repository;
determine, based on the device retirement metric, an action plan to take with respect to the returned device; and
provide, to a user, an indication of the action plan with respect to the returned device.
